(19) United States
(12) Patent Application Publication
(10) Pub. No.: US 2006/0285671 A1
(43) Pub. Date: Dec. 21, 2006

(54) Method and apparatus for dynamic authorization of conference joining

(76) Inventors: Saravanakumar V. Tiruthani, Santa Clara, CA (US); Marcelo Oliveira, San Jose, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/136,112

(22) Filed: May 24, 2005

(51) Int. Cl. H04M 3/42

(52) U.S. Cl. 379/202.01

(57) ABSTRACT

A telecommunications system includes a conferencing system configured to manage a teleconference; a plurality of user devices; wherein at least one of said plurality of user devices is designated a host and is configured to receive an announcement, provided by the conferencing system, of a participant attempting to join a teleconference hosted by the host and authorize the participant to join.

### BACKGROUND OF THE INVENTION

1. Field of the Invention

The present invention relate to telecommunications systems and, in particular, to an improved conferencing system.

2. Description of the Related Art

A known method for establishing a teleconference involves a conference host reserving time and resources at a conference bridge and creating a unique passcode. The number for the conference bridge and the passcode are sent to the prospective participants. To join the conference, prospective participants dial in at the appropriate time and enter the passcode.

For recurrent meetings the conference host may reserve the conference bridge over an extended period and publish the passcode. From time to time, conferences involving subsets of those to whom the passcode has been distributed may be required. However, the security of a given conference may be compromised, as a guest in one session may inadvertently or advertently join another conference with the same passcode.

### SUMMARY OF THE INVENTION

These and other drawbacks in the prior art are overcome in large part by a system and method according to embodiments of the present invention.

A telecommunications system according to an embodiment of the present invention includes a conferencing system configured to manage a teleconference; a plurality of user devices; wherein at least one of said plurality of user devices is designated a host and is configured to receive an announcement, provided by the conferencing system, of a participant attempting to join a teleconference hosted by the host and authorize the participant to join.

A telecommunications method according to embodiments of the present invention includes establishing a teleconference, including reserving a conference bridge and creating a passcode; prompting a prospective participant for identification information after said prospective participant has dialed in to said conference bridge and entered the passcode; presenting a request to join from said prospective participant to a conference host if said identification information is confirmed; and authorizing said prospective participant to join the conference.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram schematically illustrating a system according to embodiments of the present invention.

FIG. 2 is a diagram schematically illustrating a system according to embodiments of the present invention.

FIG. 3 illustrates a signaling diagram according to an embodiment of the present invention.

FIG. 4A illustrates an exemplary system according to an embodiment of the present invention.

FIG. 4B illustrates an exemplary server in accordance with an embodiment of the present invention.

FIG. 5 is a flowchart illustrating operation of an embodiment of the present invention.

FIG. 6 is a flowchart illustrating operation of an embodiment of the present invention.

FIG. 7 is a flowchart illustrating operation of an embodiment of the present invention.

FIG. 8 is a flowchart illustrating operation of an embodiment of the present invention.

FIG. 9 is a flowchart illustrating operation of an embodiment of the present invention.

FIG. 10 is a block diagram of an exemplary user device according to an embodiment of the present invention.

FIG. 11 is a block diagram of a server according to an embodiment of the present invention.

### DETAILED DESCRIPTION OF EMBODIMENTS OF THE INVENTION

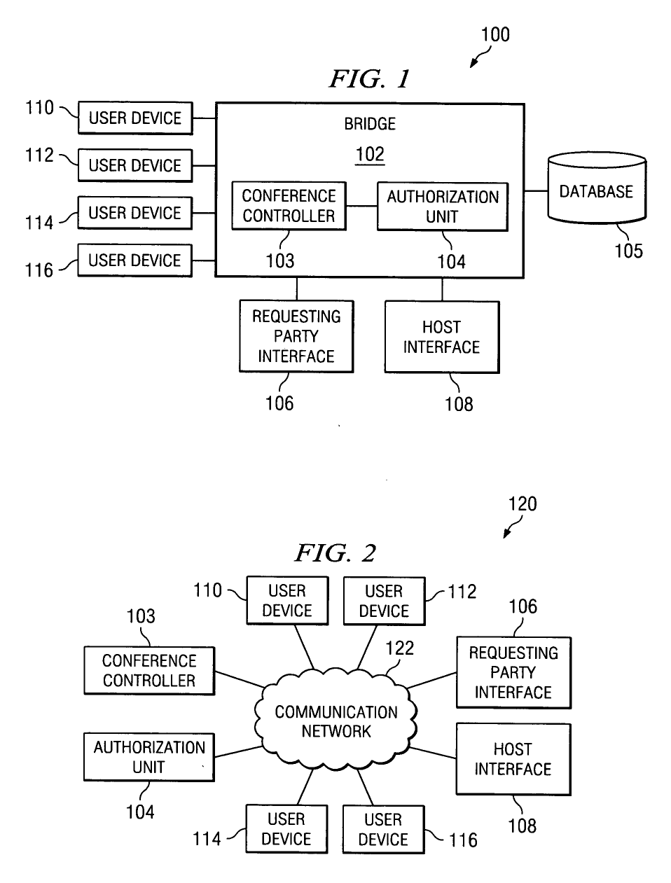

Turning now to the drawings, and with particular attention to FIG. 1, an exemplary system 100 is illustrated according to some embodiments of the present invention. The system 100 includes a conferencing bridge 102 that may be connected to or in communication with conferencing unit 103 and an authorization unit 104. An exemplary server environment or conferencing bridge capable of being adapted for use in a system according to embodiments of the present invention is the OpenScape system, available from Siemens Information and Communication Networks, Inc. Such an environment can be implemented, for example, in conjunction with Windows Server, Microsoft Office Live Communications Server, Microsoft Active Directory, Microsoft Exchange and SQL Server.

The system 100 also may be coupled to or in communication with a requesting party interface 106 and a host interface 108. As will be explained in greater detail below, the requesting party interface 106 allows a prospective participant to request entry to a teleconference. The host interface 108 allows a party already participating in the conference to accept or reject the prospective participant.

User devices, such as the user devices 110, 112, 114, 116 may be connected to or in communication with conferencing unit 103 and/or the authorization control 104 and/or the requesting party interface 106 and the host interface 108. In some embodiments, a user device may be or include such things as telephones, cellular telephones, PDAs, computers, etc. For example, the user devices 110, 112, 114, 116, may be personal computers implementing the Windows XP™ operating system. In addition, the user devices 110, 112, 114, 116 may include telephony and other multimedia messaging capability using, for example, peripheral cameras, Webcams, microphones and speakers (not shown) or peripheral telephony handsets, such as the Optipoint™ handset available from Siemens Information and Communication Networks.

The conference bridge 102, conferencing unit 103, and the authorization control 104 may be implemented in hardware and/or software operating on one or more servers, computer systems, host or mainframe computers, workstations, etc. In some embodiments the conference bridge 102, conferencing unit 103, and the authorization control 104 may be operating on some or all of the same device(s) as other components in the system 100.

As will be discussed in more detail below, in some embodiments the conference bridge 102 may include or be in communication with the conferencing unit 103 and authorization control 104 and allows for extended user notification for prospective callers. More particularly, in operation, a conference host 108 may set up a conference with the conference bridge 102, including assigning a conference passcode. A prospective caller can then call in and enter the passcode. The authorization control 1024 will then prompt the caller for additional information, which is transmitted to one or more participants, such as the host. The host can then decide whether to accept the prospective caller as a party to the conference.

In some embodiments, the system 100 may include other hardware and/or software components (e.g., gateways, proxy servers, registration servers, presence servers, redirect servers, databases, applications), such as, for example, hardware and software used to support a SIP or other protocol based infrastructure for the system 100 and allow registration of SIP devices in the system 100.

In some embodiments, one or more of the components of the system 100 may be connected or in communication with each other via a communication network. For example, now referring to FIG. 2, a system 120 including the components of the system 100 is illustrated, wherein some or all of the components are in communication via a network 122. The network 122 may be or include the Internet, the World Wide Web, a local area network, or some other public or private computer, cable, telephone, client/server, peer-to-peer, or communications network or intranet. In some embodiments, a communications network also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL connections, etc. Moreover, as used herein, communications include those enabled by wired or wireless technology. In some embodiments, some or all of the network 122 may be implemented using a TCP/IP network and may implement voice or multimedia over IP using, for example, the Session Initiation Protocol (SIP).

The authorization unit 104 may also be coupled to or in communication with one or more sets of user data or databases (not shown). The authorization unit 104 and such databases may be implemented in hardware and/or software operating on one or more servers, computer systems, host or mainframe computers, workstations, etc. In some embodiments, the authorization unit 104 may be operating on some or all of the same devices as other components in the system 100.

In some embodiments, the authorization unit 104 may be or include an application that communicates with or is connected to one or more registered devices that allows devices to register with the system 100 or helps to facilitate their registration. For example, in a SIP environment, the devices may be registered with the system 100 and may show up or be described in registration databases as being assigned to particular identities.

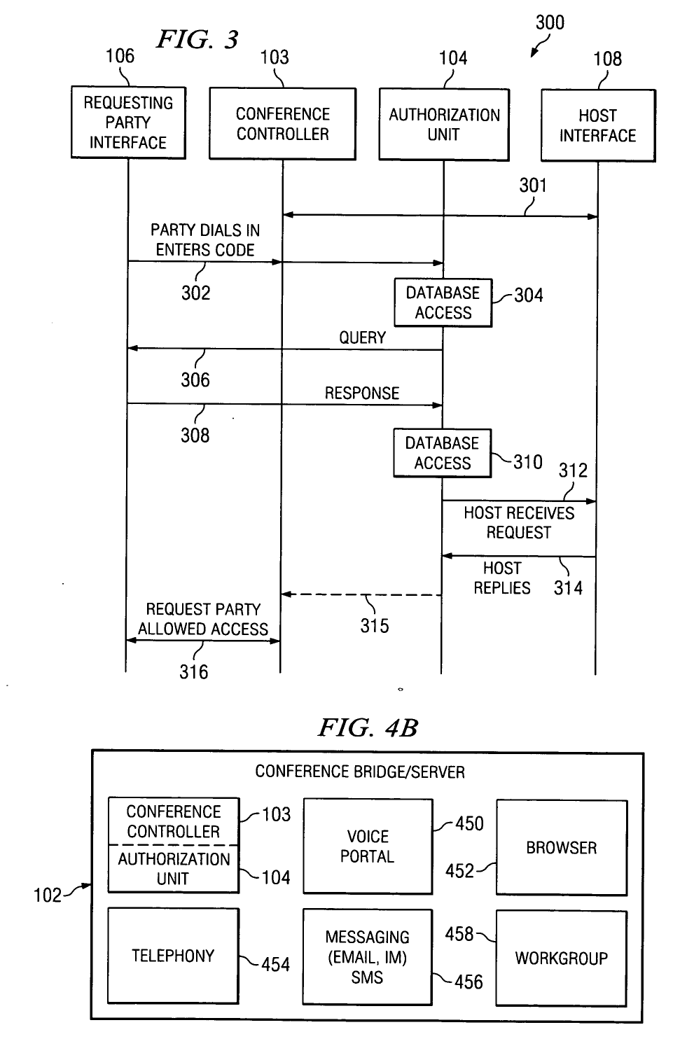

Turning now to FIG. 3, a signaling chart illustrating operation of an embodiment of the present invention is shown. Shown is a new or prospective participant or requesting party interface 106, the conferencing controller 103, authorization unit 104, and a conference host or host interface 108. In some embodiments, the conference host 108 would have arranged or reserved a time with the conferencing bridge 102 (FIG. 1), including assigning and distributing the conference telephone number and passcode. In other embodiments, the host interface 108 may be representative of any of the authorized participants in the conference.

At 301, the host and (potentially) other parties, not shown, are engaged in a conference via the conference bridge and conferencing controller 103. At 302, the prospective participant 106 dials in to the bridge and conferencing controller 103; when the bridge 102 (and, particularly, the control unit 103) answers, the user can enter the passcode. At 304, the authorization unit 104 receives the passcode and accesses a corresponding database of follow-up queries. The query for additional information is provided to the prospective participant 106 at 306. As will be described in greater detail below, the query can be provided in a variety of formats. For example, the query could be provided via a browser-type interface or via a interactive voice response interface. Further, the query could be as a text message, such as via SMS or a similar system. In certain embodiments, the host or user can set a preference for the medium in which the request and response are transmitted and received. The prospective participant can then enter the additional information at 308. Again, the information may be entered via the browser or an IVR type interface.

At 310, the authorization unit 104 accesses its rules database 105 defining the medium by which the host is to be contacted. Again, the host may be contacted via a voice (IVR) medium or via a text or browser-based medium. If contacted via a voice channel, the bridge can transmit via all channels and hence all parties to the conference, or only on the channel to the host.

At 312, the host 108 receives the notification of the request to join the conference, including the additional information provided by the prospective participant. At 314, the authorization unit 104 receives the host's response. For example, the response can be received via browser, text, voice, DTMF, and the like. At 315, the authorization unit 104 can communicate with the conference controller 103 to allow the prospective participant to join. Finally, at 316, the prospective participant 106 can be denied access or allowed access to the conference.

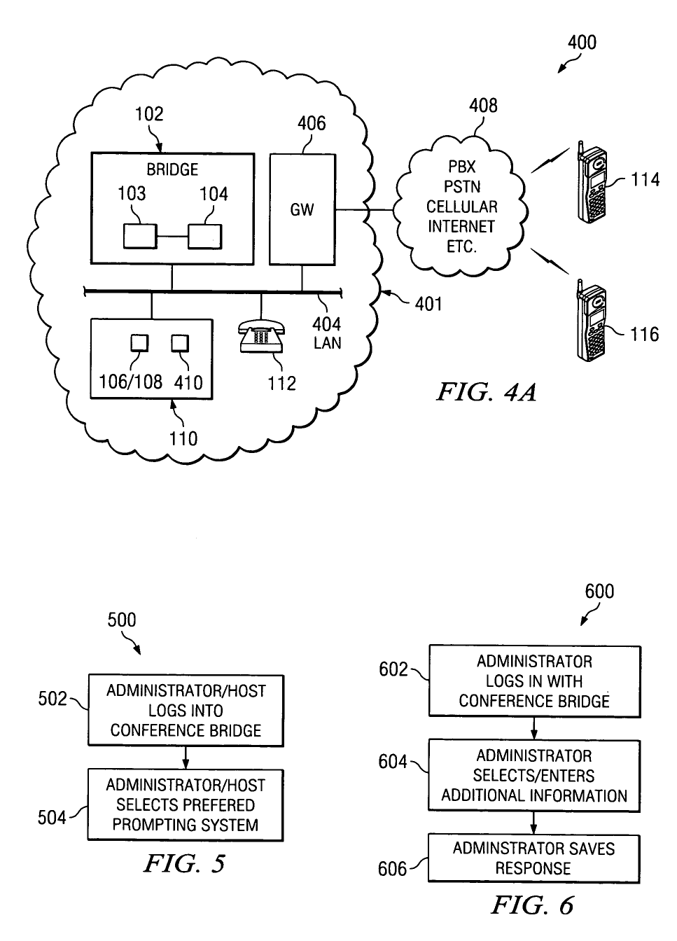

An exemplary network architecture that may be suitable for use with embodiments of the present invention is shown in FIG. 4A. As shown, the system 400 includes an enterprise network 401 and a public network 408. The enterprise network 401 may include a wired or wireless local area network (LAN) 404. A conferencing bridge or server 102 may be coupled to the LAN 404. The server may implement a conferencing control unit 103 and an authorization unit 104.

Also coupled, connected to or in communication with the LAN 304 may be one or more user devices 110, 112. The user devices 110, 112 may be implemented as personal computers 110 or digital telephones 112, such as Internet Protocol (IP) based digital telephones. An exemplary personal computer 110 may also include a browser portal 410, which can be used to define or program one or more user choices regarding query and response media. The personal computer 110 may also implement a requesting party interface 106 and/or a host interface 108, typically in conjunction with the browser 410. In addition, the computer 110 may itself include teleconferencing capabilities.

A gateway 406 may also be coupled to the LAN 404. The gateway 406 provides an interface to the public network 408, which may be implemented, for example, as one or more of the PSTN, cellular telephone network, Internet, one or more PBX's, and the like. One or more user devices 114, 116, which may be implemented as one or more telephones or cellular telephones, may be in communication with the public network 408. In certain embodiments, cellular telephones may be equipped with text or SMS messaging capabilities, allowing reception and transmission of conferencing notices. In certain embodiments, telephones 112, 114, 116 may be equipped with requesting party interfaces 106 and/or host interfaces 108.

In operation, a user, such as a host, may be associated with one or more of the devices 110, 112, 114, 116. He can use his host interface in cooperation with the browser 410 to set up a teleconference via the conferencing bridge 102, configure queries, and allow for others to join.

Turning now to FIG. 4B, a block diagram of an exemplary conferencing bridge or server 102 in accordance with embodiments of the present invention is shown. As noted above, an exemplary server environment that may be adapted for use in accordance with the teachings of the present invention is the Openscape system, available from Siemens Information and Communication Networks, Inc. The conferencing bridge 102 may include, be coupled to, or in communication with, a conferencing controller 103, an authorization unit 104, a voice portal 450, a browser portal 452, a telephony portal 454, one or more messaging portals 456, and a workgroup portal 458.

The conferencing controller 103 may be capable of supervising, mixing, etc., one or more voice or multimedia teleconferences. The voice portal 450 may be implemented as an interactive voice response (IVR) system and allow for receiving voice and/or DTMF (dual tone multifrequency) user inputs. The browser portal 452 allows for communicating with user web browsers. A telephony portal 454 allows telephony communication. The messaging portals 456 may be embodied as e-mail or instant messaging (or other text and/or multimedia messaging) systems. Finally, the workgroup portal 458 allows for users to establish workgroups and rules for workgroups. For example, teachings of the present invention may be particularly useful in situations in which the prospective participant is a “guest” to a particular workgroup and who is authorized for some, but not all workgroup functions.

Turning now to FIG. 5, a flowchart 500 illustrating operation of an embodiment of the present invention is shown. The particular arrangement of elements in the flowchart 500 is not meant to imply a fixed order to the elements; embodiments can be practiced in any order that is practicable.

More particularly, FIG. 5 illustrates a host or administrator logging in and performing configuration functions according to embodiments of the present invention. A host, for example, would want to configure the notice medium for receiving notices of parties wanting to join the conference. The administrator may select the medium for sending notices to an receiving notices from a party wishing to join a conference.

For example, in a step 502, the host or administrator can log in to the conferencing bridge 102. The host or administrator may employ, for example, a browser-type interface 410 from computer 110 (FIG. 4A) and make use of an Internet or intranet to communicate with the bridge 102. Alternatively, in other embodiments, the host or administrator may use a telephone or telephony application to contact an interactive voice response (IVR) interface 450 (FIG. 4B) on the bridge for the communication. Typically, once the user has contacted the conferencing bridge 102, the user is prompted for an identification or authentication indicating it has rights to perform the desired configuration.

In a step 504, the host or administrator can then select a preferred prompting system. For example, the user can select whether the additional prompt to the prospective participant is to be provided via an IVR system or via a browser or text messaging type system, such as a SMS system. The type of medium can depend on the caller's environment. The user can similarly select the prompting environment for the host itself (i.e., the medium through which the host or hosts receive the queries from the prospective participant).

Turning now to FIG. 6, a flowchart 600 illustrating operation of an embodiment of the present invention is shown. The particular arrangement of elements in the flowchart 600 is not meant to imply a fixed order to the elements; embodiments can be practiced in any order that is practicable.

In particular, FIG. 6 illustrates a method for a host or administrator to specify the additional query for the prospective participant to answer before being allowed into the conference. In a step 602, the administrator can log in to the conferencing server 102. For example, the user can log in using a web browser-type interface or an interactive voice interface. In a step 604, the user can use his interface, for example, to set and record an appropriate additional information for one or more prospective participants in a teleconference. Such information may include, for example, the party name or other identification. Finally, in a step 606, the user can save the response.

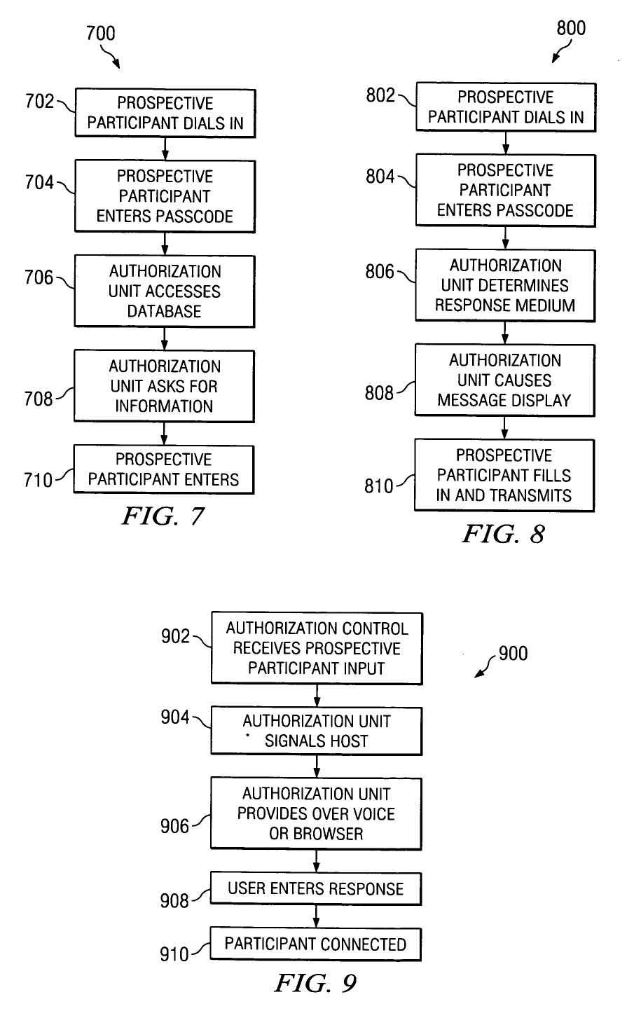

Turning now to FIG. 7, a flowchart 700 illustrating operation of an embodiment of the present invention is shown. The particular arrangement of elements in the flowchart 700 is not meant to imply a fixed order to the elements; embodiments can be practiced in any order that is practicable.

In particular, FIG. 7 illustrates call handling when the prospective participant 106 makes use of an IVR system, i.e., when the authorization unit 104 is coupled to or in communication with an IVR system 450 (FIG. 4B). In a step 702, the prospective participant can dial in to the conferencing bridge, for example using a telephone or cellular telephone. In a step 704, the prospective participant can enter the passcode, for example, by speaking the passcode, or by entering digits, such as via a DTMF keypad on his telephone. In a step 706, the authorization unit 104 receives the call and accesses a database that includes the appropriate information that is to be requested. In a step 708, the IVR asks the caller for the appropriate information. In a step 710, the caller can select the appropriate response, for example, using his telephone keypad. The response is received as one or more DTMF tones at the IVR 450.

Turning now to FIG. 8, a flowchart 800 illustrating operation of an embodiment of the present invention is shown. The particular arrangement of elements in the flowchart 800 is not meant to imply a fixed order to the elements; embodiments can be practiced in any order that is practicable.

In particular, FIG. 8 illustrates call handling when the prospective participant 106 makes use of a browser or text messaging system. In such a case, the prospective participant 106 might be calling in from a cellular telephone or in association with a computer with telephony capabilities. In a step 802, the prospective participant 106 can dial in to the conferencing bridge. In a step 804, the prospective participant can enter the passcode, for example, via DTMF tones or using a browser interface as prompted. In a step 806, the authorization unit 104 will access the appropriate control (e.g., IVR or browser) to determine the method by which the response should be made.

If the response is to be done by a browser interface, then in a step 808, the authorization unit 104 causes an appropriate message to be displayed to the prospective participant, such as a web browser screen or pop up to be displayed on the user's web browser, with appropriate fields to be filled in. Alternatively, the authorization unit could cause a text or SMS message to be sent to the prospective participant. In a step 810, the user can fill in the appropriate field(s) and/or response and transmit to the web browser.

Turning now to FIG. 9, a flowchart 900 illustrating operation of an embodiment of the present invention is shown. The particular arrangement of elements in the flowchart 900 is not meant to imply a fixed order to the elements; embodiments can be practiced in any order that is practicable.

In particular, FIG. 9 illustrates host signaling according to an embodiment of the present invention. At a step 902, an authorization control 104 receives a user input in one of the formats discussed above from a prospective participant. In a step 904, the authorization unit 104 can signal to the host that a party is attempting to join the conference. The authorization unit 104 can perform the signaling in a variety of ways, independent of the ways in which the prospective party requested access to the conference. In a step 906, for example, the authorization unit 104 could present the request over one or more voice channels. In particular, the request could come over only the host's channel or be audible to everyone in the conference. Alternatively, if the host is at a computer or other device with a graphical user interface, such as a web browser or text messaging, the request could be provided over that medium. In a step 908, the host can enter a response that will be received by the authorization unit 104. For example, the host could enter one or more DTMF tones, or speak one or more words to accept or reject the application to join the conference. Alternatively, the host could employ a web browser or other GUI. Finally, in a step 910, if the host has authorized the joining, the party can be connected.

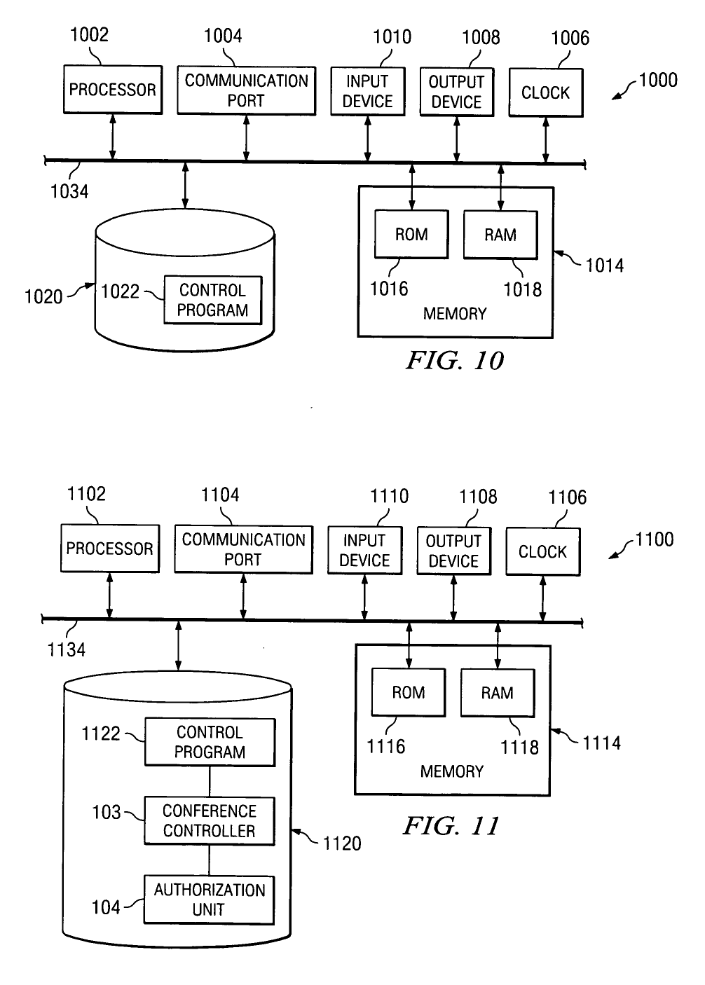

Now referring to FIG. 10, a representative block diagram of a computer or processing device 1000 suitable for use as a user device according to embodiments of the present invention is shown. In particular, the computer 1000 may be a device suitable for setting up teleconferences and setting prospective participant information. The computer 1000 may be embodied as a single device or computer, a networked set or group of devices or computers, a workstation, mainframe or host computer, etc. In some embodiments, the computer 1000 may implement one or more elements of the methods disclosed herein.

The computer 1000 may include a processor, microchip, central processing unit, or computer 1002 that is in communication with or otherwise uses or includes one or more communication ports or network interfaces 1004 for communicating with user devices and/or other devices. The communication ports 1004 may include such things as local area network adapters, wireless communication devices, Bluetooth technology, etc. The computer 1000 also may include an internal clock element 1006 to maintain an accurate time and date for the computer 1000, create time stamps for communications received or sent by the computer 1000, etc.

If desired, the computer 1000 may include one or more output devices 1008 such as a printer, infrared or other transmitter, antenna, audio speaker, display screen or monitor, text to speech converter, etc., as well as one or more input devices 1010 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the computer 1000 may include a memory or data storage device 1020 to store information, software, databases, documents, communications, device drivers, etc. The memory or data storage device 1020 may be implemented as an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc and/or a hard disk. Thus, the storage device 1020 may include various combinations of moveable and fixed storage. The computer 1000 also may include memory 1014, such as ROM 1016 and RAM 1018.

The processor 1002 and the data storage device 1020 in the computer 1000 each may be, for example: (i) located entirely within a single computer or other computing device; or (ii) connected to each other by a remote communication medium, such as a serial port cable, telephone line or radio frequency transceiver. In one embodiment, the computer 1000 may be implemented as one or more computers that are connected to a remote server computer.

A conventional personal computer or workstation with sufficient memory and processing capability may be used as the computer 1000. The computer 1000 may be capable of high volume transaction processing, performing a significant number of mathematical calculations in processing communications and database searches. A Pentium™ microprocessor such as the Pentium III™ or IV™ microprocessor, manufactured by Intel Corporation may be used for the processor 1002. Other suitable processors may be available from Motorola, Inc., AMD, or Sun Microsystems, Inc. The processor 1002 also may be embodied as one or more microprocessors, computers, computer systems, etc.

Software may be resident and operating or operational on the computer 1000. The software may be stored on the data storage device 1020 and may include a client control program 1022 for operating the computer. The client control program 1022 may include or interface to a browser interface, a host interface, messaging client, and user data.

The client control program 1022 may control the processor 1002. The processor 1002 may perform instructions of the client control program 1022, and thereby operate in accordance with the methods described in detail herein. The client control program 1022 may be stored in a compressed, uncompiled and/or encrypted format. The client control program 1022 furthermore includes program elements that may be necessary, such as an operating system, a database management system and device drivers for allowing the processor 1002 to interface with peripheral devices, databases, etc. Appropriate program elements are known to those skilled in the art, and need not be described in detail herein.

The computer 1000 also may include or store user information, such as information regarding identities, communications, etc. Such user data may be provided from other applications. Information regarding other application program data may be stored in application databases (not shown).

According to some embodiments, the instructions of the control program may be read into a main memory from another computer-readable medium, such as from the ROM 1016 to the RAM 1018. Execution of sequences of the instructions in the control program causes the processor 1002 to perform the process elements described herein. In alternative embodiments, hard-wired circuitry may be used in place of, or in combination with, software instructions for implementation of some or all of the methods described herein. Thus, embodiments are not limited to any specific combination of hardware and software.

The processor 1002, communication ports 1004, clock 1006, output device 1008, input device 1010, data storage device 1012, ROM 1016 and RAM 1018 may communicate or be connected directly or indirectly in a variety of ways. For example, the processor 1002, communication ports 1004, clock 1006, output device 1008, input device 1010, data storage device 1012, ROM 1016 and RAM 1018 may be connected via a bus 1034.

While specific implementations and hardware/software configurations for the computer 1000 have been illustrated, it should be noted that other implementations and hardware configurations are possible and that no specific implementation or hardware/software configuration is needed. Thus, not all of the components illustrated in FIG. 10 may be needed for the computer 1000 implementing the methods disclosed herein.

FIG. 11 is a diagram illustrating a server/conferencing service 1100 according to embodiments of the present invention. The server 1100 may be representative, for example, of the server or conferencing bridge of FIG. 4B. In some embodiments, the server 1100 may include or operate user programs, including, for example, authorization control programs. The server 1100 may be embodied as a single device or computer, a networked set or group of devices or computers, a workstation, mainframe or host computer, etc. In some embodiments, the server 1100 may implement one more elements of the methods disclosed herein.

The server 1100 may include a processor, microchip, central processing unit, or computer 1102 that is in communication with or otherwise uses or includes one or more communication ports 1104 for communicating with user devices and/or other devices. The communication ports 1104 may include such things as local area network adapters, wireless communication devices, telephone network adapters, Bluetooth technology, etc. The server 1100 also may include an internal clock element 1106 to maintain an accurate time and date for the server 1100, create time stamps for communications received or sent by the server 1100, etc.

If desired, the server 1100 may include one or more output devices 1108 such as a printer, infrared or other transmitter, antenna, audio speaker, display screen or monitor, text to speech converter, etc., as well as one or more input devices 1111 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 1100 may include a memory or data storage device 1120 to store information, software, databases, documents, communications, device drivers, etc. The memory or data storage device 1120 may be implemented as an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc and/or a hard disk. The server 1100 also may include memory 1114, such as ROM 1116 and RAM 1118.

The processor 1102 and the data storage device 1120 in the server 1100 each may be, for example: (i) located entirely within a single computer or other computing device; or (ii) connected to each other by a remote communication medium, such as a serial port cable, telephone line or radio frequency transceiver. In one embodiment, the server 1100 may be implemented as one or more computers that are connected to a remote server computer for maintaining databases.

A conventional personal computer or workstation with sufficient memory and processing capability may be used as the server 1100. The server 1100 may be capable of high volume transaction processing, performing a significant number of mathematical calculations in processing communications and database searches. A Pentium™ microprocessor such as the Pentium III™ or IV™ microprocessor, manufactured by Intel Corporation may be used for the processor 1102. Other suitable processors may be available from Motorola, Inc., AMD, or Sun Microsystems, Inc. The processor 1102 also may be embodied as one or more microprocessors, computers, computer systems, etc.

Software may be resident and operating or operational on the server 1100. The software may be stored on the data storage device 1120 and may include one or more control programs 1122 for operating the server, databases, etc. The control program 1122 may include or interface to the conference controller 103 and authorization unit 104.

The control program 1122 may control the processor 1102. The processor 1102 may perform instructions of the control program 1120, and thereby operate in accordance with the methods described in detail herein. The control program 1122 may be stored in a compressed, uncompiled and/or encrypted format. The control program 1122 furthermore includes program elements that may be necessary, such as an operating system, a database management system and device drivers for allowing the processor 1102 to interface with peripheral devices, databases, etc. Appropriate program elements are known to those skilled in the art, and need not be described in detail herein.

The server 1100 also may include or store information regarding identities, communications, application data, messages, etc. In some embodiments, some or all of one or more of the databases may be stored or mirrored remotely from the server.

According to some embodiments, the instructions of the control program may be read into a main memory from another computer-readable medium, such as from the ROM 1116 to the RAM 1118. Execution of sequences of the instructions in the control program causes the processor 1102 to perform the process elements described herein. In alternative embodiments, hard-wired circuitry may be used in place of, or in combination with, software instructions for implementation of some or all of the methods described herein. Thus, embodiments are not limited to any specific combination of hardware and software.

The processor 1102, communication ports 1104, clock 1106, output device 1108, input device 1111, data storage device 1112, ROM 1116, and RAM 1118 may communicate or be connected directly or indirectly in a variety of ways. For example, the processor 1102, communication ports 1102, clock 1106, output device 1108, input device 1111, data storage device 1112, ROM 1116, and RAM 1118 may be connected via a bus 034.

While specific implementations and hardware/software configurations for the server 1100 have been illustrated, it should be noted that other implementations and hardware configurations are possible and that no specific implementation or hardware/software configuration is needed. Thus, not all of the components illustrated in FIG. 11 may be needed for the server 1100 implementing the methods disclosed herein.

The methods described herein may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, in some embodiments, many, if not all, of the elements for the methods described above are optional or can be combined or performed in one or more alternative orders or sequences and the claims should not be construed as being limited to any particular order or sequence, unless specifically indicated.

Each of the methods described above can be performed on a single computer, computer system, microprocessor, etc. In addition, in some embodiments, two or more of the elements in each of the methods described above could be performed on two or more different computers, computer systems, microprocessors, etc., some or all of which may be locally or remotely configured. The methods can be implemented in any sort or implementation of computer software, program, sets of instructions, programming means, code, ASIC, or specially designed chips, logic gates, or other hardware structured to directly effect or implement such software, programs, sets of instructions, programming means or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

The foregoing description of the invention has been presented for purposes of illustration and description. It is not intended to be exhaustive or to limit the invention to the precise form disclosed, and modifications and variations are possible in light of the above teachings or may be acquired from practice of the invention. The drawings and description were chosen in order to explain the principles of the invention and its practical application. The drawings are not necessarily to scale and illustrate the device in schematic block format. It is intended that the scope of the invention be defined by the claims appended hereto, and their equivalents.

What is claimed is:

1. A telecommunications systems, comprising:
a conferencing system configured to manage a teleconference;
a plurality of user devices;
wherein at least one of said plurality of user devices is designated a host and is configured to receive an announcement, provided by the conferencing system, of a participant attempting to join a teleconference hosted by the host and authorize the participant to join.

2. A telecommunications system in accordance with claim 1, wherein the conferencing system is configured to prompt said participant attempting to join the conference for identification information.

3. A telecommunications system in accordance with claim 2, wherein the conferencing system is configured to prompt said participant attempting to join the conference for identification information after a passcode identifying the conference is provided.

4. A telecommunications system in accordance with claim 3, wherein the conferencing system includes an interactive voice response system for prompting said participant.

5. A telecommunications system in accordance with claim 3, wherein the conferencing system includes graphical user interface system for prompting said participant.

6. A telecommunications system in accordance with claim 5, wherein the graphical user interface system for prompting said participant includes a web browser.

7. A telecommunications system in accordance with claim 5, wherein the graphical user interface system for prompting said participant includes text messaging client.

8. A telecommunications system in accordance with claim 1, wherein the host is configured to authorize the participant using a graphical user interface.

9. A telecommunications system in accordance with claim 8, wherein the graphical user interface is a web browser.

10. A telecommunications system in accordance with claim 1, wherein the host is configured to authorize the participant using an interactive voice response interface.

11. A telecommunications method, comprising:
establishing a teleconference, including reserving a conference bridge and creating a passcode;
prompting a prospective participant for identification information after said prospective participant has dialed in to said conference bridge and entered the passcode;
presenting a request to join from said prospective participant to a conference host if said identification information is confirmed; and
authorizing said prospective participant to join the conference.

12. A telecommunications method in accordance with claim 11, wherein said prompting a prospective participant includes prompting using an interactive voice response system.

13. A telecommunications method in accordance with claim 11, wherein said prompting a prospective participant includes prompting using a graphical user interface system.

14. A telecommunications method in accordance with claim 11, wherein said presenting includes using an interactive voice response system.

15. A telecommunications method in accordance with claim 11, wherein said presenting includes using a graphical user interface system.

16. A telecommunications method in accordance with claim 11, wherein said authorizing includes using an interactive voice response system.

17. A telecommunications method in accordance with claim 11, wherein said authorizing includes using a graphical user interface system.
